(19) United States
(12) Patent Application Publication
(10) Pub. No.: US 2015/0251160 A1
(43) Pub. Date: Sep. 10, 2015

(54) HIERARCHICALLY POROUS AMINE-SILICA MONOLITH AND PREPARATION METHOD THEREOF

(71) Applicant: KOREA INSTITUTE OF SCIENCE AND TECHNOLOGY, Seoul (KR)

(72) Inventors: Ung Su CHOI, Seoul (KR); Young Gun KO, Seoul (KR); Hyun Jeong LEE, Seoul (KR); Hyun Chul OH, Seoul (KR); Tae Gu DO, Seoul (KR)

(21) Appl. No.: 14/471,475

(22) Filed: Aug. 28, 2014

(30) Foreign Application Priority Data
Mar. 5, 2014 (KR) 10-2014-0026202

(51) Int. Cl. B01J 20/30; B01J 20/22; B01J 20/28

(52) U.S. Cl. CPC B01J 20/3078; B01J 20/28042; B01J 20/22

(57) ABSTRACT

The present invention relates to an adsorbent including a hierarchically porous silica monolith, and particularly, to an adsorbent for adsorbing or separating carbon dioxide in air or heavy metals in an aqueous solution, in which an amino group is covalently bonded to the silica monolith. Further, the present invention relates to a method for preparing the adsorbent including a hierarchically porous silica monolith, and particularly, to a method for preparing an adsorbent for adsorbing or separating carbon dioxide in air or heavy metals in an aqueous solution, in which an amino group is covalently bonded to the silica monolith.

### CROSS-REFERENCE TO RELATED APPLICATION

Pursuant to 35 U.S.C. §119(a), this application claims the benefit of earlier filing date and right of priority to Korean Application No. 10-2014-0026202, filed on Mar. 5, 2014, the contents of which is incorporated by reference herein in its entirety.

### BACKGROUND OF THE DISCLOSURE

1. Field of the Disclosure

The present disclosure relates to an adsorbent including a hierarchically porous silica monolith, and particularly, to an adsorbent for adsorbing or separating carbon dioxide in air or heavy metals in an aqueous solution, in which an amino group is covalently bonded to the silica monolith.

Further, the present disclosure relates to a method for preparing the adsorbent including a hierarchically porous silica monolith, and particularly, to a method for preparing an adsorbent for adsorbing or separating carbon dioxide in air or heavy metals in an aqueous solution, in which an amino group is covalently bonded to the silica monolith.

2. Background of the Disclosure

As the amount of fossil fuel used is increased due to an increase in population and the development of industrialization, the concentration of carbon dioxide in the atmosphere is significantly increased, thereby accelerating global warming such as greenhouse effects. In addition, contamination of drinking water by heavy metals due to the development of various industries is also increasing. Furthermore, an increase in concentration of indoor carbon dioxide in addition to the environmental contamination is responsible for increasing the possibility of causing the workers' fatigue and accidents such as careless driving. Research and development on adsorbents have been actively conducted in order to deal with the increasing level of carbon dioxide, and organic/inorganic adsorbents, in which an inorganic amine functional group has been introduced into a support having nanopores, are excellent in terms of efficiency of adsorption and regeneration, and thus have been abundantly developed.

For these organic/inorganic adsorbents, adsorption proceeds at normal temperature and normal pressure, and in the case of desorption for regeneration, desorption of carbon dioxide adsorbed in the atmosphere is performed under the conditions of normal pressure, 100° C. and nitrogen atmosphere. Further, heavy metals adsorbed on an organic/inorganic adsorbent in an aqueous solution are desorbed by immersing the adsorbent in an adsorbed state in a NaCl or KCl solution at high concentration.

The adsorbent is usually prepared by introducing a functional group into a porous silica or carbon material having a large specific surface area, or mixing with the functional group during the preparation process to cause a reaction to occur. Among the adsorbents, porous silica such as SBA-x and MCM-x has good advantages such as a large specific surface area, a uniform pore size and the possibility of introducing various functional groups, and thus is highlighted as a material for an adsorbent. However, since it is difficult to synthesize the silica in a large amount or manufacture the adsorbent in the form of a module, or the silica is present in the form of powder, there is a problem in that it is not easy to deal with the silica. Thus, there is need for a novel adsorbent to solve the conventional problems, and a preparation method thereof.

### PRIOR ART DOCUMENT

### Patent Document

Korean Patent Application Publication No. 10-2013-0052245, MANUFACTURING OF GRAPHENE NANOSHEET FOR CARBON DIOXIDE ADSORBENT

Korean Patent Application Publication No. 10-2013-0112572, Carbon adsorbent for CO□ adsorption and manufacturing method thereof

### Non-Patent Document

Journal of the American Chemical Society, 2008, 130, 2902-2903

### SUMMARY OF THE DISCLOSURE

Therefore, an aspect of the detailed description is to provide an adsorbent including a hierarchically porous silica monolith, and particularly, an adsorbent for adsorbing or separating carbon dioxide in air or heavy metals in an aqueous solution, in which an amino group is covalently bonded to the silica monolith.

Further, another aspect of the detailed description is to provide a method for preparing the adsorbent including a hierarchically porous silica monolith, and particularly, a method for preparing an adsorbent for adsorbing or separating carbon dioxide in air or heavy metals in an aqueous solution, in which an amino group is covalently bonded to the silica monolith.

To achieve these and other advantages and in accordance with the purpose of this specification, as embodied and broadly described herein, an adsorbent including a hierarchically porous silica monolith is provided.

The adsorbent may be an adsorbent in which an amino group is covalently bonded to the silica monolith.

The hierarchically porous structure denotes a structure in which micro-sized pores and nano-sized pores are present in a mixed state, the micro-sized pores may have a diameter in a range from 200 to 900 μm, and the nano-sized pores may have a diameter in a range from 2 to 30 nm.

The adsorbent may be adhesive-free.

The adsorbent may be for adsorbing carbon dioxide or heavy metals.

The silica monolith may be at least one selected from the group consisting of SBA-15, SBA-16, SBA-12, MCM-41, MCM-48, FSM-16, FDU-1, FDU-12, and KIT-5.

The amino group may be derived from at least one selected from the group consisting of (3-aminopropyl) trimethoxysilane, [3-(methylamino) propyl] trimethoxysilane, [3-(diethylamino) propyl] trimethoxysilane, [3-(2-aminoethyl) aminopropyl] trimethoxysilane, and 3-[2-(2-aminoethylamino) ethylamino] propyl-trimethoxysilane.

A method for preparing an adsorbent containing a hierarchically porous silica monolith according to an exemplary embodiment of the present invention in order to achieve the objects includes: (a) immersing a polyurethane foam in a silica sol solution; (b) aging the immersed polyurethane foam; and (c) calcining the aged polyurethane foam to form a hierarchically porous silica monolith.

The preparation method may further include (d) covalently bonding an amino group to the hierarchically porous silica monolith.

In the preparation method, step (b) may be performed by repeatedly applying pressure such that the silica sol solution permeates well into the polyurethane foam.

The preparation method may completely remove the polyurethane foam by performing step (c) while injecting nitrogen thereto.

In the preparation method, the hierarchically porous structure denotes a structure in which micro-sized pores and nano-sized pores are present in a mixed state, the micro-sized pores may have a diameter in a range from 200 to 900 μm, and the nano-sized pores may have a diameter in a range from 2 to 30 nm.

The diameter of the micro-sized pores is determined in accordance with the diameter of the pores of the polyurethane foam used, and the diameter of the micro-sized pores may be controlled by selecting the polyurethane foam used above.

The diameter of the nano-sized pores may be controlled by adjusting the pH or concentration of the silica sal solution used, or adjusting the time or temperature at which step (b) or step (c) is performed.

The preparation method may be for preparing an adsorbent for adsorbing carbon dioxide or heavy metals.

In the preparation method, the silica monolith may be at least one selected from the group consisting of SBA-15, SBA-16, SBA-12, MCM-41, MCM-48, FSM-16, FDU-1, FDU-12, and KIT-5.

In the preparation method, step (d) may be performed in a gas phase by evaporating an amino silane compound, or in a liquid phase by dissolving an amino silane compound in anhydrous toluene.

The amino silane may be at least one selected from the group consisting of (3-aminopropyl) trimethoxysilane, [3-(methylamino) propyl] trimethoxysilane, [3-(diethylamino) propyl] trimethoxysilane, [3-(2-aminoethyl) aminopropyl] trimethoxysilane, and 3-[2-(2-aminoethylamino) ethylamino] propyl-trimethoxysilane.

Hereinafter, the present invention will be described in detail.

An aspect of the present invention is an adsorbent including a hierarchically porous silica monolith (HPSM).

The hierarchically porous silica monolith is a silica monolith having a wall structure, in which micro-sized pores and nano-sized pores are present in a mixed state. The hierarchically porous structure to be formed in the silica monolith of the present invention may be formed by immersing a polyurethane foam in a silica sol solution, and then subjecting the immersed polyurethane foam to aging and calcination. Specifically, when the layer is separated into three layers by leaving the silica sol to stand, the clear upper layer is removed, the intermediate layer and the lower layer are well mixed to prepare a silica sol at high concentration, and then the polyurethane foam is immersed in the sol. In order to form the silica monolith of the present invention, it is essential to remove the upper layer because a silica sol which is not subjected to the process is too thin for the silica monolith to be formed. Thereafter, the foam is repeatedly compressed and allowed to expand such that the sol permeates well into the foam, the foam is subjected to aging such that the sol solution is well adsorbed on the foam and micro pores are formed, and then the foam may be subjected to calcination to prepare a hierarchically porous silica monolith. In the calcination, nitrogen may be injected to completely remove the polyurethane foam and prepare a monolith which consists only of silica.

The hierarchically porous structure to be formed in the silica monolith of the present invention may have pores with various sizes other than a uniform pore size to maximize a specific surface area. Accordingly, an adsorbent using the same has excellent physical adsorption capability by which a material to be adsorbed, such as carbon dioxide or heavy metals, may be adsorbed. In particular, when an adsorption functional group for adsorbing carbon dioxide or heavy metals on the surface of the hierarchically porous silica is further introduced in relation to the adsorption action, the adsorption action is reinforced from the viewpoint of chemical adsorption capability, and thus the adsorption capability may be expected to be enhanced more than before the functional group of the silica monolith is introduced.

The adsorbent for adsorbing carbon dioxide or heavy metals may be a solid physical adsorbent. This is based on the capability of a porous solid material which reversibly adsorbs specific components in a mixture. A general adsorbing solid material has pores, and the size of the pores may be controlled, but the size of pores in the solid material is at a uniform level with only a deviation. Therefore, until now, there has not been any known adsorbing solid material having a size of hierarchical pores, particularly, both micro-sized pores and nano-sized pores. However, the present inventors have provided the adsorbable hierarchically porous silica monolith, in which micro-sized pores and nano-sized pores are present in a mixed state in a solid material as described above, thereby significantly enhancing physical adsorption capability of an adsorbent which may be prepared therefrom,

A higher selectivity in relation to adsorption of carbon dioxide or heavy metals may be achieved by bonding a compound which provides chemical adsorption to the solid adsorbent as described above. For this purpose, in a specific exemplary embodiment, the adsorbent provided in the present invention may be an adsorbent in which an amino group is chemically bonded to the hierarchically porous silica monolith. Preferably, the adsorbent may be an adsorbent in which an amino group is covalently bonded to the surface of the hierarchically porous silica monolith. Accordingly, effectiveness as an adsorbent may be maintained for a long period of time compared to the existing amine-bonded adsorbents by means of physical adsorption, in which chemical adsorption capability deteriorates due to repeated adsorption-desorption.

The amino group may be present in an amount of about 25 wt % to about 75 wt % of the adsorbent. Preferably, the amino group may be present in an amount of about 30 wt % of the adsorbent.

In a specific exemplary embodiment, the adsorbent provided in the present invention provides an advantage in that selectivity for carbon dioxide or heavy metals is high under both room temperature and elevated-temperature conditions, for example, in a range from 20° C. to 100° C., and adsorption capability is excellent. Therefore, the adsorbent of the present invention may selectively capture and separate carbon dioxide or heavy metals as a target material, and the efficiency thereof is very high. The adsorbent of the present invention is easily regenerated and recycled in a wide temperature range, and thus enables a plurality of adsorption-desorption cycles without any loss of activity.

The adsorbent provided in the present invention introduces an amino group into the surface of the hierarchically porous silica through a chemical covalent bond instead of introducing an amino group into the surface of the silica through physical adsorption. Further, the porous silica is a hierarchically porous silica having a pore size from a nano size to a micro size and has a very large specific surface. Accordingly, physical adsorption capability for an object to be adsorbed such as carbon dioxide or heavy metals may be maximized. The bonding of the amino group may be performed by evaporating an amino silane-based compound on the surface of the aforementioned hierarchically porous silica monolith in a reduced pressure state in which temperature is adjusted, or dissolving the amino silane-based compound in an organic solvent and obtaining bonding through a chemical reaction, and as a result, an adsorbent (HPSM-NH₂), to which an amino group is bonded, is prepared.

In a specific exemplary embodiment, the adsorbent provided in the present invention may be an adsorbent in which an amino group is bonded to the silica monolith of the present invention by using an amino silane-based compound. The amino group may be primary, secondary and tertiary alkyl amino groups and alkanol amino groups, an aromatic amino group, a mixed amino group, and a combination thereof. An adsorbent to which the primary amino group or the secondary amino group is bonded may have the highest activity for adsorbing carbon dioxide or heavy metals. Examples of the amino silane-based compound include (3-aminopropyl) trimethoxysilane, [3-(methylamino) propyl] trimethoxysilane, [3-(diethylamino) propyl] trimethoxysilane, [3-(2-aminoethyl) aminopropyl] trimethoxysilane, and 3-[2-(2-aminoethylamino) ethylamino] propyl-trimethoxysilane, but are not limited thereto.

The hierarchically porous structure to be formed in the silica monolith of the present invention denotes a structure in which micro-sized pores and nano-sized pores are present in a mixed state. The micro-sized pores may be controlled by adjusting the pore size of a polyurethane foam which is a material corresponding to a prototype of the silica monolith. Conveniently, the silica monolith may be prepared by selecting target polyurethane foams having pores in a micro-size range in a final adsorbent among commercially available polyurethane foams. The size of the micro-sized pores may be controlled by using a polyurethane foam having different pore sizes, and the micro-sized pores may be controlled by adjusting the pH and concentration of the silica sol, the time for aging and calcinations during the preparation method, the temperature of aging and calcination, and the like. In a specific exemplary embodiment, micro-sized pores of the final adsorbent provided in the present invention may have a diameter in a range from 200 to 900 μm, and nano-sized pores thereof may have a diameter in a range from 2 to 20 nm. Preferably, the micro-sized pores may have a diameter in a range from 400 to 900 μm and the nano-sized pores may have a diameter in a range from 1 to 10 nm, and more preferably, the micro-sized pores may have a diameter in a range from 600 to 900 μm and the nano-sized pores may have a diameter in a range from 5 to 10 nm.

The adsorbent provided in the present invention is adhesive-free. Since a polyurethane foam is used as a prototype to prepare a molded silica monolith having the form of a polyurethane foam which is a prototype other than a powder form therefrom, the adsorbent of the present invention does not need adhesion with a structure having a certain form, such as polyurethane, to which an adsorbent should be subjected in order to allow the conventional porous silica having no formability to have a certain form. Accordingly, it is not necessary to use an adhesive such as resol, and a silica having nano-sized pores may be directly subjected to calcination to prepare and form a hierarchically porous silica monolith in the form of a polyurethane foam.

In a specific exemplary embodiment, the adsorbent may be for adsorbing carbon dioxide, or heavy metals (ions) such as Cu²⁺, Al³⁺, Ag⁺, Fe²⁺, Fe³⁺, Ni²⁺, Zn²⁺, and Pb²⁺. In addition, the adsorbent provided in the present invention may be repeatedly used a plurality of times, and may be regenerated by applying heat, reduced pressure, vacuum, a gas purging, a lean sweep gas, and a combination thereof to desorb the adsorbed material, for example, carbon dioxide or heavy metals. Carbon dioxide may be naturally released, or released from any supply source including industrial exhaust and combustion gas from fossil fuel power plants.

In a specific exemplary embodiment, the silica monolith included in the adsorbent may be at least one selected from the group consisting of SBA-15, SBA-16, SBA-12, MCM-41, MCM-48, FSM-16, FDU-1, FDU-12, and KIT-5.

Another aspect of the present invention is a method for preparing an adsorbent containing a hierarchically porous silica monolith. The preparation method of the present invention includes: (a) immersing a polyurethane foam in a silica sol solution; (b) aging the immersed polyurethane foam; and (c) calcining the aged polyurethane foam to form a hierarchically porous silica monolith.

According to the general method for preparing an adsorbent in the related art, it is difficult to prepare an adsorption material having uniform nano-sized pores, and an adsorption material having nano-sized pores is not easily mass-produced. Further, silica as a conventional adsorption material used in the adsorbent is a particle, and thus has a disadvantage in that additional costs for processing a form are incurred when a module is manufactured by using the silica. In addition, even when a module is charged with silica in the form of particle, there is a problem in that a large amount of pressure is lost depending on the flow rate of a material to be adsorbed, for example, carbon dioxide or heavy metals. However, the method for preparing an adsorbent including a hierarchically porous silica monolith provided in the present invention provides a solution to the aforementioned problems. As described above, the hierarchically porous silica structure is a silica monolith having a wall structure, in which micro-sized pores and nano-sized pores are present in a mixed state, and the hierarchically porous structure is an adsorption material which may have pores with various sizes other than pores with an almost uniform size to maximize a specific surface area for adsorption, and thus is very excellent in adsorption capability for a material to be adsorbed. The hierarchically porous structure of the silica monolith of the present invention may be formed by immersing a polyurethane foam in a silica sol solution, and then subjecting the immersed polyurethane foam to aging and calcination. Specifically, when the layer is separated into three layers by leaving the silica sol to stand, the clear upper layer is removed, the intermediate layer and the lower layer are well mixed to prepare a silica sol at high concentration, and then the polyurethane foam is immersed in the sol. The foam is repeatedly compressed and allowed to expand such that the sol permeates well into the foam, the foam is subjected to aging such that the sol solution is well adsorbed on the foam and micro pores are formed, and then the foam may be subjected to calcination to prepare a hierarchically porous silica monolith. In the calcination, nitrogen may be injected to completely remove the polyurethane foam and prepare a monolith which consists only of silica.

In the preparation method, step (b) may be performed by repeatedly applying pressure such that the silica sol solution permeates well into the polyurethane foam.

The preparation method may completely remove the polyurethane foam by performing step (c) while injecting nitrogen thereto. The polyurethane foam is thermally decomposed and removed by injecting nitrogen, and in this case, when polyurethane is not completely removed, it is preferred to completely remove polyurethane because it is difficult to form a silica monolith in which an amino group is finally introduced.

The silica monolith prepared by the preparation method of the present invention has an advantage in that the silica monolith need not be subjected to additional molding process for allowing the silica monolith to have a form, and forms a structure by itself because the formability of the polyurethane foam which is a prototype is maintained as it is in addition to characteristics of having a hierarchically porous structure. Furthermore, due to the formability itself, an unnecessary adhesive may not be used compared to the conventional case where silica in the form of particle is adhered to another structure having formability, and adhesion efficiency may be excellent more than enough.

Further, for the adsorption action, adsorption capability in the adsorbent finally prepared may be chemically enhanced by introducing a chemical adsorption functional group for adsorbing carbon dioxide or heavy metals into the surface of the silica having a hierarchically porous structure as described above. For this purpose, in a specific exemplary embodiment, the present invention may provide a method for preparing an adsorbent in which a chemical adsorption functional group is introduced into the surface of silica having a hierarchically porous structure. Preferably, the preparation method may further include (d) covalently bonding an amino group to the hierarchically porous silica monolith. The adsorbent provided in the present invention may be an adsorbent in which an amino group is introduced into the surface of the porous silica through a chemical covalent bond other than an amino group being introduced into the surface of the silica through physical adsorption.

Step (d) may be performed in a gas phase by evaporating an amino silane compound, or in a liquid phase by dissolving an amino silane compound in anhydrous toluene.

The bonding of an amino group, which is performed in a gas phase, may be achieved by a method for evaporating an amino silane compound in an elevated temperature state or in a state where pressure is additionally reduced. Specifically, a covalent bond is formed with the surface of the silica monolith while the amino silane compound is evaporated and adsorbed on the surface of the silica monolith, and then a silane group is decomposed. That is, when the amino silane compound is brought into contact with a hydroxyl group of the silica monolith, the contact means that the silane group is boned to the hydroxyl group while being broken. In order for the covalent bond to be formed, a temperature within a few degrees of 120° C. is appropriate, and the gas phase reaction may be performed at a temperature of, for example, 100° C. to 140° C., preferably 110° C. to 130° C., and more preferably about 120° C. This is because the strongest covalent bond may be formed at a temperature of about 120° C. In addition, the reduced pressure condition means a degree of vacuum of 50 mmHg or less, and when pressure is reduced to 50 mmHg or less within the temperature range, the amino silane compound may be easily evaporated, thereby contributing to the formation of the covalent bond. Preferably, the reduced pressure condition may be a degree of vacuum of 20 mmHg or less.

The bonding of an amino group, which is performed in a liquid phase, may be achieved by a method for bonding an amino group by dissolving an amino silane compound in an organic solvent. As a result, an adsorbent (HPSM-NH₂), to which an amino group is bonded, may be prepared. Examples of the organic solvent include anhydrous toluene, anhydrous hexane, and xylene, but are not limited thereto. The bonding of an amino group, which is performed in a liquid phase, begins from the adsorption of an amino silane compound dissolved in an organic solvent such as anhydrous toluene at normal temperature on the surface of a silica monolith immersed in anhydrous toluene. Thereafter, it is appropriate to perform a reaction by increasing temperature to a temperature within a few degrees of 120° C. likewise in the above-described reaction of forming a covalent bond in a gas phase, because the strongest covalent bond may be formed at a temperature of about 120° C. Accordingly, a reaction of bonding the amino group, which is performed in a liquid phase, may also be performed at a temperature of, for example, 100° C. to 140° C., preferably 110° C. to 130°, and more preferably about 120° C.

Preferably, an amino group may be bonded to the silica monolith of the present invention by using an amino silane-based compound. The amino group may be primary, secondary and tertiary alkyl amino groups and alkanol amino groups, an aromatic amino group, a mixed amino group, and a combination thereof. An adsorbent to which the primary amino group or the secondary amino group is bonded may have the highest activity for adsorbing carbon dioxide or heavy metals. The amino group may be an amino group which has low volatility in order to avoid or minimize the release of amine, which contaminates the gas stream and decreases the efficiency of an adsorbent as time passes. Examples of the amino silane-based compound include (3-aminopropyl) trimethoxysilane, [3-(methylamino) propyl] trimethoxysilane, [3-(diethylamino) propyl] trimethoxysilane, [3-(2-aminoethyl) aminopropyl] trimethoxysilane, and 3-[2-(2-aminoethylamino) ethylamino] propyl-trimethoxysilane, but are not limited thereto.

As described above, the hierarchically porous structure denotes a structure in which micro-sized pores and nano-sized pores are present in a mixed state, the micro-sized pores may have a diameter in a range from 200 to 900 μm, and the nano-sized pores may have a diameter in a range from 2 to 30 nm. The diameter of the micro-sized pores is determined in accordance with the diameter of the pores of the polyurethane foam used, and the diameter of the micro-sized pores may be controlled by selecting the polyurethane foam used above. The diameter of the nano-sized pores may be controlled by adjusting the pH or concentration of the silica sol solution used, or adjusting the time or temperature at which step (b) or step (c) is performed. Preferably, step (b) may be performed at 80° C. for 48 hours, and step (c) may be performed at 550° C. for 5 hours, in order to obtain an appropriate diameter of nano-sized pores.

The adsorbent including the hierarchically porous silica monolith of the present invention, particularly, the adsorbent in which an amino group is covalently bonded to the silica monolith may provide a function of separating, capturing or adsorbing carbon dioxide and a function of adsorbing and removing heavy metals from an aqueous solution including the heavy metals. The adsorbent of the present invention may provide an adsorbent in which physical adsorption capability is maximized through a hierarchically porous structure, and the adsorption capability is chemically reinforced by arbitrarily attaching a chemical adsorption functional group thereto through a covalent bond. Further, for the adsorbent of the present invention, an adsorption module is more easily prepared than for powder and particulate adsorbents, and thus may be prepared in a desired form, and when the adsorbent is used in a system for separating carbon dioxide, an adsorption system may be easily mounted thereon, shows excellent adsorption ratio, may be detached therefrom, and may be regenerated and used. In addition, the adsorption capability for heavy metals in wastewater is excellent, and the adsorbent of the present invention may be used in a wastewater purification facility.

Furthermore, the method for preparing an adsorbent including the hierarchically porous silica monolith of the present invention, particularly, the method for preparing an adsorbent in which an amino group is covalently bonded to the silica monolith is a simple method, and has an advantage in that it is possible to prepare a silica monolith containing both micro-sized pores and nano-sized pores and having a maximized specific surface area, and simultaneously an additional process for formality molding is not required. According to the method of the present invention, a diameter of micro-sized pores may be controlled by selecting a polyurethane foam, and a diameter of nano-sized pores may also controlled by adjusting conditions of aging and calcination processes, thereby providing an adsorbent for carbon dioxide or heavy metals, in which the adsorption capability is controlled, if necessary.

Further scope of applicability of the present application will become more apparent from the detailed description given hereinafter. However, it should be understood that the detailed description and specific examples, while indicating preferred embodiments of the disclosure, are given by way of illustration only, since various changes and modifications within the spirit and scope of the disclosure will become apparent to those skilled in the art from the detailed description.

### BRIEF DESCRIPTION OF THE DRAWINGS

The accompanying drawings, which are included to provide a further understanding of the disclosure and are incorporated in and constitute a part of this specification, illustrate exemplary embodiments and together with the description serve to explain the principles of the disclosure.

In the drawings:

FIG. 1 is a concept view of preparing an adsorbent (HPSM-NH₂) by modifying a hierarchically porous silica monolith (HPSM) which is an exemplary embodiment of the present invention with APTMS, illustrating a concept view in which a polyurethane foam is used as a prototype, and TEOS is used as a silica precursor.

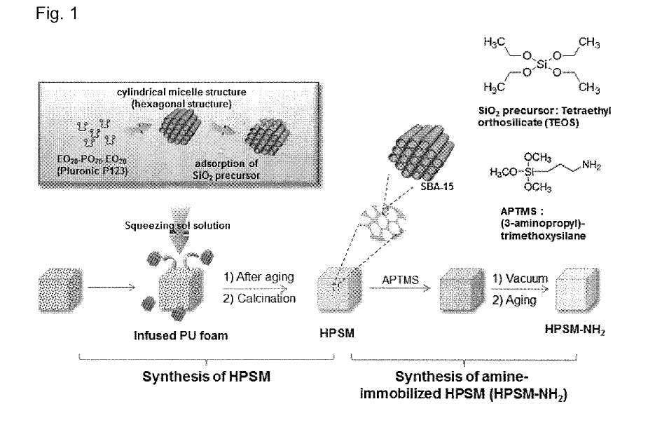

FIG. 2 illustrates Fourier transform infrared spectra of the HPSM prepared in Example 1 and the HPSM-NH₂ prepared in Example 2.

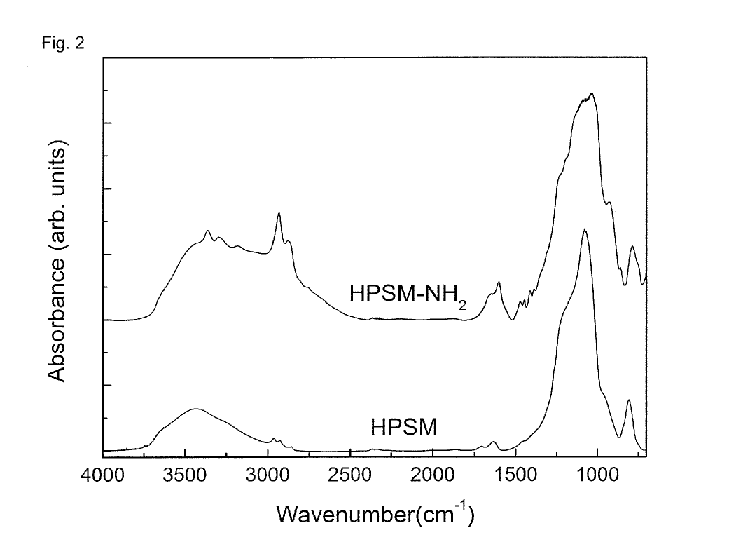

FIG. 3A shows a photograph and an electron microscope photograph of the polyurethane foam used in Example 1 of the present invention.

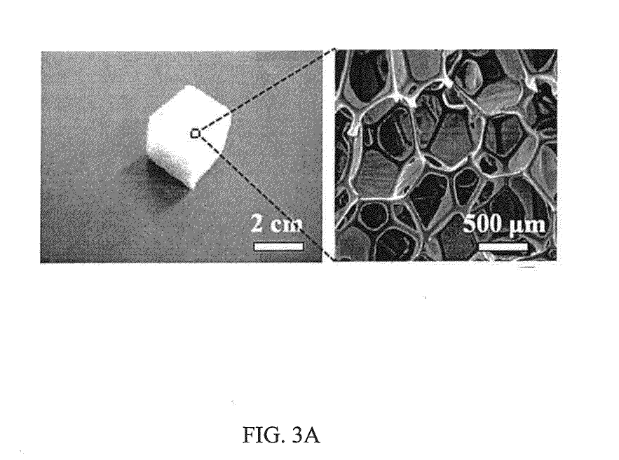

FIG. 3B shows a photograph, an electron microscope photograph, and a transmission electron microscope photograph of the HPSM prepared in Example 1 of the present invention.

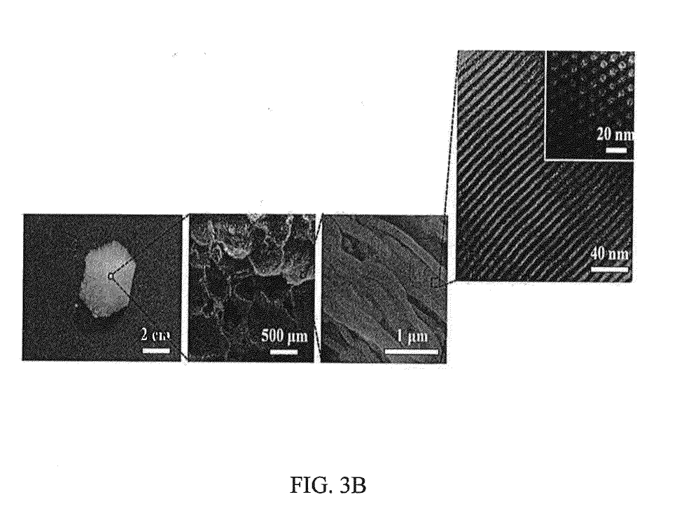

FIG. 3C shows a photograph, an electron microscope photograph, and a transmission electron microscope photograph of the HPSM-NH₂ prepared in Example 2 of the present invention.

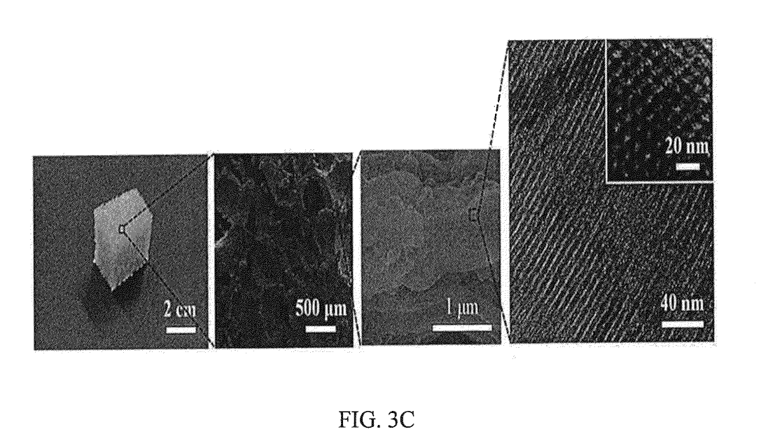

FIG. 4 is a carbon dioxide adsorption-desorption curve, which is a result obtained by repeating the test of adsorbing and desorbing carbon dioxide using the HPSM-NH₂ prepared in Example 2 of the present invention.

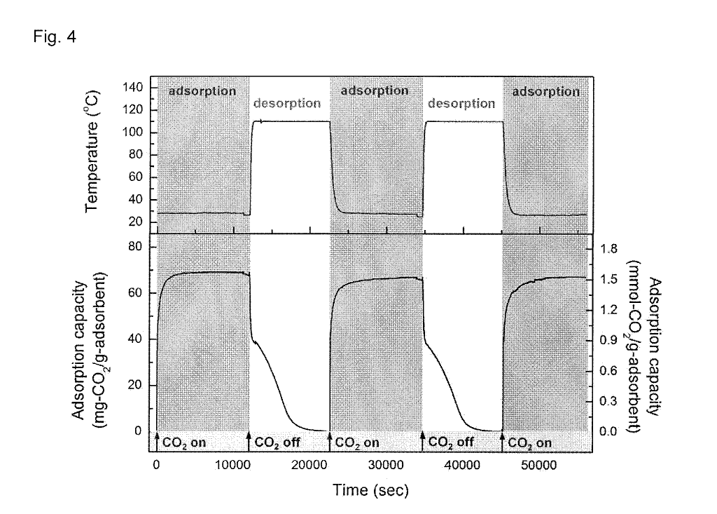

### DETAILED DESCRIPTION OF THE DISCLOSURE

Description will now be given in detail of the exemplary embodiments, with reference to the accompanying drawings. For the sake of brief description with reference to the drawings, the same or equivalent components will be provided with the same reference numbers, and description thereof will not be repeated.

Hereinafter, exemplary embodiments of the present invention will be described in detail with reference to the accompanying drawings, such that those skilled in the art to which the present invention pertains can easily carry out the invention. However, the present invention can be implemented in various different forms, and is not limited to the exemplary embodiments described herein.

Information on the manufacturers of the materials used in the following Examples is as follows:

Pluronic P123 (Aldrich Chemical Co.), 2N HCl (Sigma-Aldrich Chemical Co.), Deionized purified water (prepared in a laboratory by using a Milli-Q water system), tetraethyl orthosilicate (Aldrich Chemical Co.), and amino silane compounds (Aldrich Chemical Co.)

### EXAMPLE 1

### Preparation of Hierarchically Porous Silica Monolith (HPSM)

4 g of Pluronic P123 as a surfactant was put into a mixed solution of 120 g of 2N HCl and 30 g of deionized purified water (DI water) and was well dissolved therein at 50° C. for 5 hours, tetraethyl orthosilicate (TEOS) was slowly added thereto dropwise, then stirring was stopped, and the reactant was precipitated for 24 hours.

The upper layer as a clear layer was taken out from the precipitate formed into three layers by a dropper, the remaining two layers were well stirred, a polyurethane foam made into a desired shape and size was placed therein, and was repeatedly compressed and allowed to expand with a finger such that the sol permeated into the foam.

The reaction was performed at 80° C. in an oven for 48 hours, temperature was elevated to 550° C. while blowing in nitrogen gas at a flow rate of 0.7 L/min for 90 minutes, and then calcination was performed for 5 hours. After the calcination, nitrogen was blown in while temperature was decreasing down to 100° C. to prepare a hierarchically porous silica monolith (HPSM).

### EXAMPLE 2

### Preparation of HPSM-APTMS Adsorbent to which APTMS is Bonded

1 mL of (3-aminopropyl) trimethoxysilane (APTMS) per 1 cm³ of the HPSM prepared in Example 1 was put into a reactor to which a vacuum pump was connected, and a reaction was performed for 24 hours while maintaining a vacuum state at 120° C. After the reaction, unreacted APTMS was removed under vacuum at normal temperature for 1 hour or more, and an adsorbent in which 3-aminopropyl trimethoxysilane was bonded to HPSM was prepared.

### EXAMPLE 3

### Preparation of HPSM-MAPTMS Adsorbent to which MAPTMS is Bonded

An adsorbent in which [3-(methylamino) propyl] trimethoxysilane was bonded to HPSM was prepared by performing the same procedure as in Example 2, except that 1 mL of [3-(methylamino) propyl] trimethoxysilane (MAPTMS) was used instead of (3-aminopropyl) trimethoxysilane (APTMS).

### EXAMPLE 4

### Preparation of HPSM-DEAPTMS Adsorbent to which DEAPTMS is Bonded

An adsorbent in which [3-(diethylamino) propyl] trimethoxysilane was bonded to HPSM was prepared by performing the same procedure as in Example 2, except that 1 mL of [3-(diethylamino) propyl] trimethoxysilane (DEAPTMS) was used instead of (3-aminopropyl) trimethoxysilane (APTMS).

### EXAMPLE 5

### Preparation of HPSM-AEAPTMS Adsorbent to which AEAPTMS is Bonded

An adsorbent in which [3-(2-aminoethyl) aminopropyl] trimethoxysilane was bonded to HPSM was prepared by performing the same procedure as in Example 2, except that 1 mL of [3-(2-aminoethyl) aminopropyl] trimethoxysilane (AEAPTMS) was used instead of (3-aminopropyl) trimethoxysilane (APTMS).

### EXAMPLE 6

### Preparation of HPSM-AEAEAPTMS Adsorbent to which AEAEAPTMS is Bonded

An adsorbent in which 3-[2-(2-aminoethylamino) ethylamino] propyl-trimethoxysilane was bonded to HPSM was prepared by performing the same procedure as in Example 2, except that 1 mL of 3-[2-(2-aminoethylamino) ethylamino] propyl-trimethoxysilane (AEAEAPTMS) was used instead of (3-aminopropyl) trimethoxysilane (APTMS).

### EXAMPLE 7

### Evaluation of Carbon Dioxide Adsorption/Desorption Performance

A carbon dioxide adsorption/desorption experiment was performed by using the HPSM-NH₂ prepared in Example 2. Carbon dioxide gas was injected into the reactor in which HPSM-N H₂ was placed while maintaining the temperature at 25° C., and the amount of carbon dioxide adsorbed by means of HPSM-NH₂ was measured by a thermogravimetric analyzer (TGA). During the desorption, the amount of carbon dioxide desorbed was measured by the thermogravimetric analyzer while blowing nitrogen gas in the reactor at 110° C., and the experiment was performed several times by repeating the adsorption and desorption processes at a unit of 10,000 seconds. Since the evaluation of the adsorption/desorption performance of carbon dioxide using the HPSM-NH₂ prepared in Example 2 demonstrated that the experiment of Example 2 in which HPSM-NH₂ was repeatedly used also exhibited excellent adsorption and desorption performance, it can be confirmed that not only adsorption and desorption performance was excellent, but also the regeneration capability was excellent when the HPSM-NH₂ of the present invention was used as an adsorbent, and little deterioration in performance was exhibited even in a repeated use of the adsorbent about 20 times.

While preferred embodiment of the present invention have been described in detail, it is to be understood that the scope of the present invention is not limited thereto, and various modifications and variations made by those skilled in the art using basic concepts of the present invention defined in the following claims also fall within the scope of the present invention.

The foregoing embodiments and advantages are merely exemplary and are not to be considered as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds are therefore intended to be embraced by the appended claims.

What is claimed is:

1. An adsorbent comprising a hierarchically porous silica monolith,

2. The adsorbent of claim 1, wherein an amino group is covalently bonded to the silica monolith of the adsorbent.

3. The adsorbent of claim 1, wherein the hierarchically porous structure denotes a structure in which micro-sized pores and nano-sized pores are present in a mixed state, and the micro-sized pores have a diameter in a range from 200 to 900 μm and the nano-sized pores have a diameter in a range from 2 to 30 nm.

4. The adsorbent of claim 1, wherein the adsorbent is adhesive-free.

5. The adsorbent of claim 1, wherein the adsorbent is for adsorbing carbon dioxide or heavy metals.

6. The adsorbent of claim 1, wherein the silica monolith is at least one selected from the group consisting of SBA-15, SBA-16, SBA-12, MCM-41, MOM-48, FSM-16, FDU-1, FDU-12, and KIT-5.

7. The adsorbent of claim 2, wherein the amino group is derived from at least one selected from the group consisting of (3-aminopropyl) trimethoxysilane, [3-(methylamino) propyl] trimethoxysilane, [3-(diethylamino) propyl] trimethoxysilane, [3-(2-aminoethyl) aminopropyl] trimethoxysilane, and 3-[2-(2-aminoethylamino) ethylamino] propyl-trimethoxysilane.

8. A method for preparing an adsorbent containing a hierarchically porous silica monolith, the method comprising:
(a) immersing a polyurethane foam in a silica sol solution;
(b) aging the immersed polyurethane foam; and
(c) calcining the aged polyurethane foam to form a hierarchically porous silica monolith.

9. The method of claim 8, further comprising:
(d) covalently bonding an amino group to the hierarchically porous silica monolith.

10. The method of claim 8, wherein step (b) is performed by repeatedly is applying pressure such that the silica sol solution permeates completely into the polyurethane foam.

11. The method of claim 8, wherein the polyurethane foam is completely removed by performing step (c) while injecting nitrogen thereto.

12. The method of claim 8, wherein the hierarchically porous structure denotes a structure in which micro-sized pores and nano-sized pores are present in a mixed state, and the micro-sized pores have a diameter in a range from 200 to 900 μm and the nano-sized pores have a diameter in a range from 2 to 30 nm.

13. The method of claim 12, wherein a diameter of the micro-sized pores is determined in accordance with a diameter of the pores of the polyurethane foam used, and a diameter of the micro-sized pores is capable to being controlled by selecting the polyurethane foam used.

14. The method of claim 12, wherein a diameter of the nano-sized pores is capable to being controlled by adjusting a pH or concentration of the silica sol solution used, or by adjusting a time or a temperature at which step (b) or step (c) is performed.

15. The method of claim 8, wherein the adsorbent is for adsorbing carbon dioxide or heavy metals.

16. The method of claim 8, wherein the silica monolith is at least one selected from the group consisting of SBA-15, SBA-16, SBA-12, MCM-41, MCM-48, FSM-16, FDU-1, FDU-12, and KIT-5.

17. The method of claim 9, wherein step (d) is performed in a gas phase by evaporating an amino silane compound, or in a liquid phase by dissolving an amino silane compound in anhydrous toluene.

18. The method of claim 17, wherein the amino silane is at least one selected from the group consisting of (3-aminopropyl) trimethoxysilane, [3-(methylamino) propyl] trimethoxysilane, [3-(diethylamino) propyl] trimethoxysilane, [3-(2-aminoethyl) aminopropyl] trimethoxysilane, and 3-[2-(2-aminoethylamino) ethylamino] propyl-trimethoxysilane.
